(19) United States
(12) Patent Application Publication
(10) Pub. No.: US 2020/0112655 A1
(43) Pub. Date: Apr. 9, 2020

(54) CAMERA MODULE

(71) Applicant: Primax Electronics Ltd., Taipei (TW)

(72) Inventor: Yi-Ching Tsai, Taipei (TW)

(21) Appl. No.: 16/200,136

(22) Filed: Nov. 26, 2018

(30) Foreign Application Priority Data
Oct. 5, 2018 (TW) 107135274

(51) Int. Cl. H04N 5/217; H04N 5/225; G02B 27/00; G03B 17/12

(52) U.S. Cl. CPC H04N 5/2171; H04N 5/2252; H04N 5/2254; G03B 17/12; G02B 27/0006

(57) ABSTRACT

The present invention relates to a camera module, including a casing, a lens assembly, a sensing chip assembly, a protecting cover, and a cleaning element. The casing includes an opening and an accommodating structure. The accommodating structure is located on a side of the opening. The lens assembly is close to the opening, and the sensing chip assembly is connected to the lens assembly. The protecting cover is located between the opening and the lens assembly, and is movable relative to the casing. The cleaning element is disposed on the accommodating structure, and is in contact with the protecting cover, to come into contact with the protecting cover and wipe the protecting cover when the protecting cover moves relative to the casing.

### FIELD OF THE INVENTION

The present invention relates to a camera module, and in particular, to a camera module having a cleaning function.

### BACKGROUND OF THE INVENTION

In recent years, portable electronic devices such as a mobile communications device and a personal digital assistant (PDA) are increasingly popularized. A camera module is disposed on each of the portable electronic devices, so that a user can use the camera module for photographing whenever and wherever possible, to generate memorable images or videos. A camera module in any form includes a lens assembly and a sensing chip. A function of the lens assembly is refracting external light and allowing the external light to pass through to perform an imaging operation. The sensing chip includes a sensing area. A function of the sensing area is receiving the external light to image on the sensing area. In this way, an image is generated.

The imaging operation of the camera module needs to enable the sensing area to receive the external light passing through the lens assembly. Therefore, the sensing area and the lens assembly need to be completely clean and dustless so that an image of good quality can be formed. The sensing area is sealed inside the camera module, and is not likely to be polluted by dust. Therefore, a cleaning operation on the lens assembly is important. Therefore, a camera module having a cleaning function appears on the market, as described in Chinese Patent Application No. CN101438200.

In a camera module of the Chinese Patent Application No. CN101438200, a protecting cover is used as a tool for cleaning a lens assembly. The protecting cover can cover the lens assembly for protection when no photographing is needed, and clean the lens assembly, or perform a cleaning operation when the lens assembly is dirty and polluted. However, some camera modules need to keep photographing. For example, a camera module (commonly referred to as an automobile data recorder) that can record images during driving needs to keep photographing to generate videos corresponding to the images during driving. In other words, the Chinese Patent Application No. CN101438200 cannot be applied to such a camera module.

Therefore, a camera module that can perform a cleaning operation during photographing is required.

### SUMMARY OF THE INVENTION

A main objective of the present invention is to provide a camera module that can perform photographing and cleaning simultaneously.

In a preferred embodiment, the present invention provides a camera module, including a casing, a lens assembly, a sensing chip assembly, a protecting cover, and a cleaning element. The casing includes an opening and an accommodating structure, where the accommodating structure is located on a side of the opening. The lens assembly is disposed in the casing and is close to the opening, and the sensing chip assembly is disposed in the casing and is connected to the lens assembly. The protecting cover is disposed in the casing and is located between the opening and the lens assembly, is configured to protect the lens assembly, and is movable relative to the casing. The cleaning element is disposed on the accommodating structure and is in contact with the protecting cover, and is configured to come into contact with the protecting cover and wipe the protecting cover when the protecting cover moves relative to the casing.

In a preferred embodiment, the camera module in the present invention further includes a water pipe, where the water pipe is disposed at one end of the accommodating structure, to form a hole at the other end of the accommodating structure, and the water pipe is configured to allow cleaning liquid to pass through; the hole is exposed on the other side of the accommodating structure and is close to the protecting cover; and when the protecting cover moves relative to the casing, the cleaning liquid is sprayed on the protecting cover through the water pipe and the hole.

In a preferred embodiment, the cleaning element is located on a side of the lens assembly without blocking a photographing area corresponding to the lens assembly.

In conclusion, cleaning elements are respectively disposed on two sides of the opening of the casing of the camera module in the present invention, and the protecting cover is disposed between the opening and the lens assembly and is movable relative to the casing. Therefore, the cleaning elements can perform a cleaning operation on the protecting cover when the protecting cover moves. Therefore, the camera module in the present invention can perform a photographing operation and the cleaning operation simultaneously, to resolve a problem in a conventional technology.

### BRIEF DESCRIPTION OF THE DRAWINGS

FIG. 1 is a schematic structural diagram of a camera module in a preferred embodiment according to the present invention;

FIG. 2 is a schematic structural exploded view of a camera module in a preferred embodiment according to the present invention;

FIG. 3 is a schematic structural exploded view of a camera module in a preferred embodiment from another angle of view according to the present invention; and

FIG. 4 is a schematic structural diagram of a camera module performing a cleaning operation in a preferred embodiment according to the present invention.

### DETAILED DESCRIPTION OF THE PREFERRED EMBODIMENT

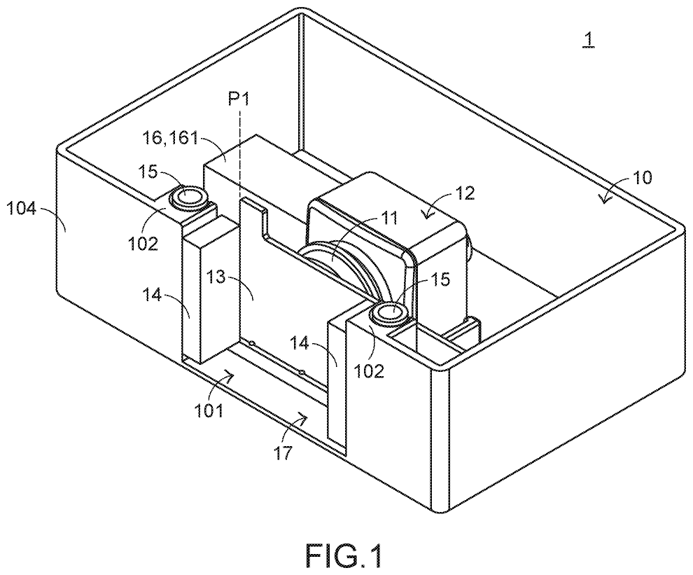

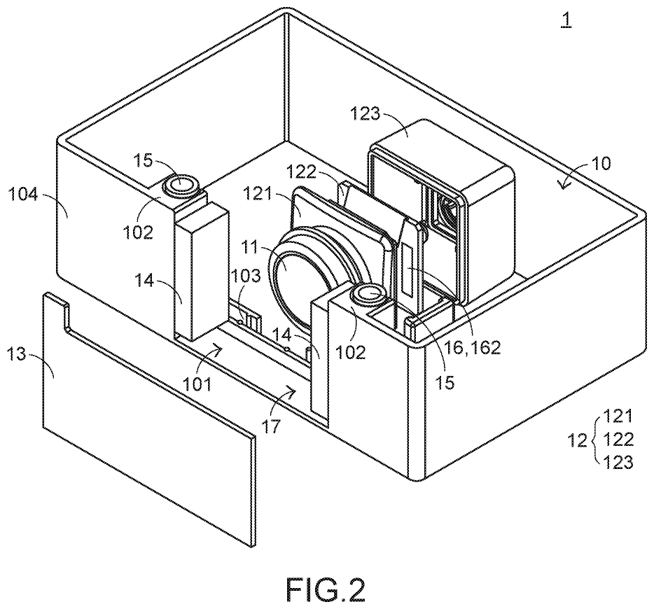

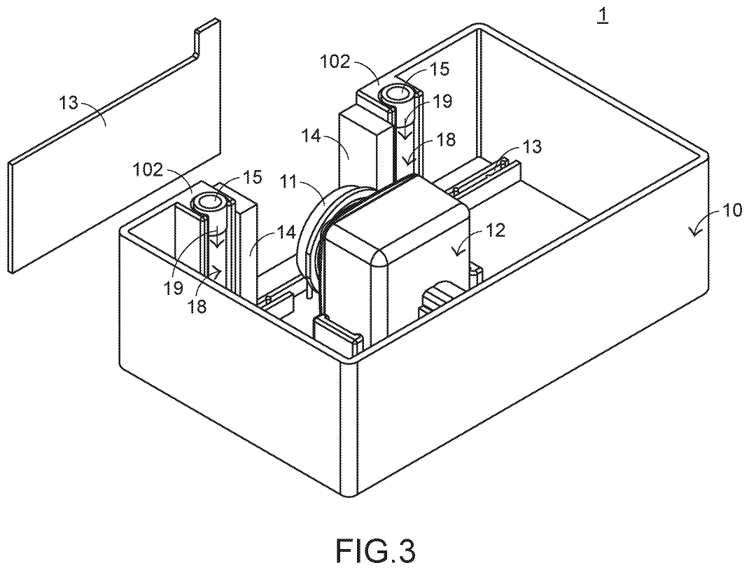

In view of a problem in a conventional technology, the present invention provides a camera module, to overcome a disadvantage of the conventional technology. A structure of the camera module in the present invention is first described. FIG. 1 is a schematic structural diagram of a camera module in a preferred embodiment according to the present invention. FIG. 2 is a schematic structural exploded view of a camera module in a preferred embodiment according to the present invention. FIG. 3 is a schematic structural exploded view of a camera module in a preferred embodiment from another angle of view according to the present invention. A camera module 1 includes a casing 10, a lens assembly 11, a sensing chip assembly 12, a protecting cover 13, a plurality of cleaning elements 14, a plurality of water pipes 15, and a control module 16. The casing 10 includes an opening 101, a plurality of accommodating structures 102, and a track 103. The opening 101 is formed in a center of a side wall 104 of the casing 10. The plurality of accommodating structures 102 is respectively located on two sides of the opening 101. The track 103 is close to the opening 101. A function of the track 103 is accommodating the protecting cover 13, and track 103 is capable of guiding the protecting cover 13 to move relative to the casing 10. In this preferred embodiment, the plurality of accommodating structures 102 and the track 103 are integrally formed with the casing 10.

In FIG. 1, FIG. 2, and FIG. 3, the lens assembly 11 is disposed in the casing 10 and is close to the opening 101. In addition, an area in front of the lens assembly 11 and the opening 101 is defined as a photographing area 17. A function of the lens assembly 11 is allowing external light to pass through. In addition, the lens assembly 11 includes a plurality of lenses. The lens assembly 11 may change a path of the external light according to a feature of the plurality of lenses. The sensing chip assembly 12 is disposed in the casing 10 and is connected to the lens assembly 11. The sensing chip assembly 12 includes a sensing chip 121, a circuit board 122, and a packaging housing 123. The sensing chip 121 is connected to the lens assembly 11. A function of the sensing chip 121 is receiving the external light passing through the lens assembly 11 to generate an image. The circuit board 122 is connected to the sensing chip 121, to supply power to the sensing chip 121. The packaging housing 123 wraps the sensing chip 121 and the circuit board 122, to protect the sensing chip 121 and the circuit board 122. In this preferred embodiment, a sensing element 111 is a complementary metal-oxide-semiconductor (CMOS), and a circuit board 112 is a rigid flex, a copper foil substrate (an FR4 substrate), or a ceramic substrate.

The protecting cover 13 is disposed in the track 103 of the casing 10, and is located between the opening 101 and the lens assembly 11, that is, is located within a range of the photographing area 17. The photographing area 17 is defined as a range that can be photographed by the camera module 1, and the photographing area 17 of the camera module 1 is included in a range of the opening 101. A function of the protecting cover 13 is protecting the lens assembly 11, and is movable relative to the casing 10. Each cleaning element 14 corresponds to one accommodating structure 102. The cleaning element 14 is disposed on the corresponding accommodating structure 102, and is in contact with the protecting cover 13. The cleaning element 14 may come into contact with the protecting cover 13 and wipe the protecting cover 13 when the protecting cover 13 moves relative to the casing 10, to perform a cleaning operation on the protecting cover 13. The plurality of cleaning elements 14 is respectively located on two sides of the lens assembly 11 without blocking the photographing area 17 corresponding to the lens assembly 11. In this preferred embodiment, the cleaning element 14 may be optionally a cleaning sponge or a cleaning brush, and the protecting cover 13 is made of a light transmission material for visible light or invisible light to pass through the protecting cover 13. In a preferred practice, a film coating layer may be formed on the protecting cover or the protecting cover is made of a special plastic material, to prevent invisible light of a particular wavelength from passing through the protecting cover according to requirements.

The control module 16 is disposed in the casing 10 and is connected to the sensing chip assembly 12 and the protecting cover 13. The control module 16 includes a power assembly 161 and a control unit 162. The power assembly 161 is disposed in the casing 10 and is connected to the protecting cover 13. A function of the power assembly 161 is providing power for the protecting cover 13, so that the protecting cover 13 is movable relative to the track 103 of the casing 10. The control unit 162 is disposed on the circuit board 122 of the sensing chip assembly 12 and is connected to the power assembly 161. The control unit 162 can control operation of the power assembly 161. In this preferred embodiment, the control unit 162 is a microprocessor, and the power assembly 161 includes a motor and a linkage structure that is connected to the protecting cover 13.

In FIG. 1, FIG. 2, and FIG. 3, each water pipe 15 corresponds to one accommodating structure 102 and one cleaning element 14. Each of the plurality of water pipes 15 is disposed at one end of the corresponding accommodating structure 102, to form a hole 18 at the other end of the accommodating structures 102, and the water pipe 15 may allow cleaning liquid 19 to pass through. In addition, the hole 18 is exposed on the other side of the accommodating structure 102 and is close to the protecting cover 13. By using such a structure, when the protecting cover 13 moves relative to the casing 10 and is close to the accommodating structure 102, the cleaning liquid 19 may be sprayed on the protecting cover 13 through the water pipe 15 and the hole 18, as shown in FIG. 3. In this preferred embodiment, the cleaning liquid 19 may be water or any liquid having cleaning efficacy.

It should be particularly noted that the camera module 1 further includes a water storage tank (not shown) and a plurality of adjusting valves (not shown). The water storage tank is connected to the plurality of water pipes 15 and can accommodate the cleaning liquid 19. Each adjusting valve corresponds to one water pipe 15. The adjusting valve is disposed on the corresponding water pipe and is connected to the control unit 162 of the control module 16, and may open or close the water pipe 15 according to operation of the control unit 162, to control whether the cleaning liquid 19 enters the water pipe 15. This is only used as an example, and the present invention is not limited thereto. In another preferred embodiment, a plurality of water pipes may be alternatively connected to an external water source, and a water storage tank does not need to be disposed in a camera module 1.

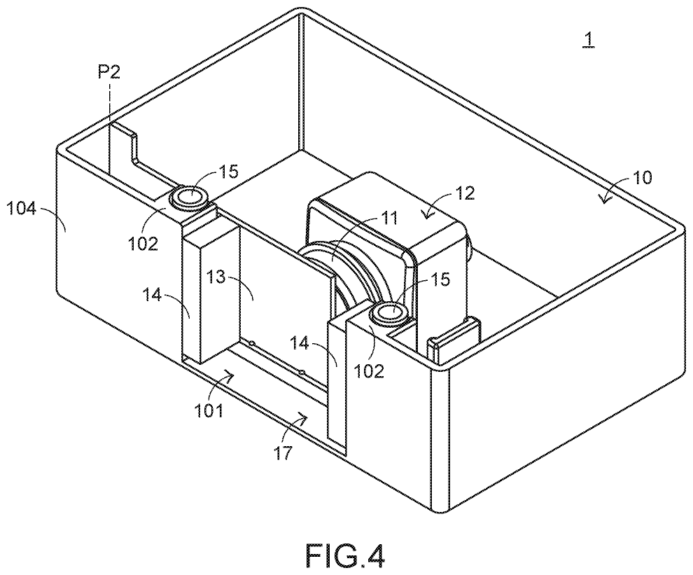

Then an operation case of the camera module 1 in the present invention is described. Refer to FIG. 1 to FIG. 4. FIG. 4 is a schematic structural diagram of a camera module performing a cleaning operation in a preferred embodiment according to the present invention. When the control unit 162 is intended to perform the cleaning operation on the camera module 1 according to a setting, the control unit 162 drives the power assembly 161, so that the protecting cover 13 moves from a first position P1 in FIG. 1 to a second position P2 in FIG. 4 along the track 103. In addition, the control unit 162 also drives the adjusting valves to open the plurality of water pipes 15, so that the cleaning liquid 19 enters the plurality of water pipe 15, and the cleaning liquid 19 may be sprayed on the protecting cover 13 through the water pipe 15 and the corresponding hole 18. Moreover, according to movement of the protecting cover 13, when the cleaning element 14 comes into contact with the protecting cover 13, the cleaning element 14 also comes into contact with the cleaning liquid 19 on the protecting cover 13. In this way, the cleaning element 14 may wipe the protecting cover 13 to perform a cleaning operation on the protecting cover 13.

Four points need to be particularly noted. First, during the cleaning operation on the protecting cover 13, the control unit 162 may be set to control the protecting cover 13 to keep moving between the first position P1 and the second position P2 till the cleaning operation is completed. Second, operation of driving the power assembly 161 and operation of the adjusting valves by the control unit 162 are precisely calculated to generate a time difference, so that when the protecting cover 13 passes the accommodating structure 102 on a left side of FIG. 1, the cleaning liquid 19 may be exactly sprayed on the protecting cover 13 through the corresponding water pipe 15 and the hole 18. The cleaning liquid 19 is blocked by the protecting cover 13. Therefore, the cleaning liquid 19 is not sprayed on the lens assembly 11 and the sensing chip assembly 12. Operation when the protecting cover 13 passes the accommodating structure 102 on a right side of FIG. 1 is similar, and details are not described again.

Third, the camera module in the present invention is not limited to performing the cleaning operation by necessarily using the cleaning liquid. The cleaning elements may alternatively be separately used to clean the protecting cover. That is, the camera module in the present invention is not limited to necessarily disposing elements such as the water pipes, the water storage tank, and the adjusting valve in the camera module. Fourth, it can be learned from FIG. 1 to FIG. 4 that the plurality of cleaning elements 14 is respectively located on two sides of the lens assembly 11 without blocking the photographing area 17 of the lens assembly 11. Therefore, the camera module 1 in the present invention has a function of performing a cleaning operation during photographing without affecting operation of the camera module 1.

It can be learned from the description above that the cleaning elements are respectively disposed on the two sides of the opening of the casing of the camera module in the present invention, and the protecting cover is disposed between the opening and the lens assembly and is movable relative to the casing. Therefore, the cleaning elements can perform the cleaning operation on the protecting cover when the protecting cover moves. Therefore, the camera module in the present invention can perform a photographing operation and the cleaning operation simultaneously, to resolve a problem in a conventional technology.

The above description is only preferred embodiments of the present invention, and is not intended to limit the scope of the claims of the present invention. Therefore, any other equivalent variations and modifications made without departing from the spirit disclosed in the present invention shall fall within the scope of the claims of this application.

What is claimed is:

1. A camera module, comprising:
a casing, comprising an opening and an accommodating structure, wherein the accommodating structure is located on a side of the opening;
a lens assembly, disposed in the casing and close to the opening;
a sensing chip assembly, disposed in the casing and connected to the lens assembly;
a protecting cover, disposed in the casing and located between the opening and the lens assembly, configured to protect the lens assembly, and movable relative to the casing; and
a cleaning element, disposed on the accommodating structure and in contact with the protecting cover, and configured to come into contact with the protecting cover and wipe the protecting cover when the protecting cover moves relative to the casing.

2. The camera module according to claim 1, wherein the casing further comprises a track, close to the opening, configured to accommodate the protecting cover, and capable of guiding the protecting cover to move relative to the casing.

3. The camera module according to claim 1, wherein the sensing chip assembly comprises:
a sensing chip, connected to the lens assembly, and configured to receive external light passing through the lens assembly to generate an image;
a circuit board, connected to the sensing chip; and
a packaging housing, wrapping the sensing chip and the circuit board.

4. The camera module according to claim 3, further comprising a control module, wherein the control module is disposed in the casing and is connected to the sensing chip assembly and the protecting cover, and the control module comprises:
a power assembly, disposed in the casing and connected to the protecting cover, and configured to provide power for the protecting cover, so that the protecting cover is movable relative to the casing; and
a control unit, disposed on the circuit board and connected to the power assembly, and configured to control operation of the power assembly.

5. The camera module according to claim 1, further comprising a water pipe, wherein the water pipe is disposed at one end of the accommodating structure, to form a hole at the other end of the accommodating structure, and the water pipe is configured to allow cleaning liquid to pass through; the hole is exposed on the other side of the accommodating structure and is close to the protecting cover; and when the protecting cover moves relative to the casing, the cleaning liquid is sprayed on the protecting cover through the water pipe and the hole.

6. The camera module according to claim 5, further comprising an adjusting valve, wherein the adjusting valve is disposed on the water pipe and is connected to a control module, and is configured to open or close the water pipe according to operation of the control module, to control whether the cleaning liquid enters the water pipe.

7. The camera module according to claim 5, further comprising a water storage tank, wherein the water storage tank is connected to the water pipe, and is configured to accommodate the cleaning liquid.

8. The camera module according to claim 1, wherein the cleaning element is located on a side of the lens assembly without blocking a photographing area corresponding to the lens assembly.

9. The camera module according to claim 1, wherein the cleaning element is a cleaning brush or a cleaning sponge.

10. The camera module according to claim 1, wherein the protecting cover is made of a light transmission material.
